(19) United States
(12) Patent Application Publication
(10) Pub. No.: US 2021/0392912 A1
(43) Pub. Date: Dec. 23, 2021

(54) PROCESS FOR PRODUCING A CANNABIS INFUSED OLIVE OIL

(71) Applicants: Gino Crudo, Vancouver (CA); Kiriako Karataruk, Vancouver (CA)

(72) Inventors: Gino Crudo, Vancouver (CA); Kiriako Karataruk, Vancouver (CA)

(21) Appl. No.: 16/904,530

(22) Filed: Jun. 17, 2020

(51) Int. Cl. A23D 9/007; A23L 33/105; A23D 9/04; A23L 29/00

(52) U.S. Cl. CPC A23D 9/007; A23L 29/035; A23D 9/04; A23L 33/105

(57) ABSTRACT

Processes for making cannabis infused olive oil are disclosed herein. The processes include steps for placing an empty drum on a heating plate, adding olive oil to the drum, adding a biological mass to the drum, heating the drum, raising the temperature in the drum, maintaining heat on the drum for a prescribed period of time, and then draining the contents from the drum into a container. Additional steps include testing the contents prepared in the drum for quality.

### FIELD OF THE INVENTION

This invention relates to medicinal extracts. More particularly, it relates to cannabis-related products and extracts.

### BACKGROUND

Cannabis products have been consumed in various forms for thousands of years. The first descriptions of the medical uses date from Chinese herbal texts in the first century A.D. Cannabis products were taken orally in an herbal tea concoction and were used for their pain-relieving and sleep-inducing properties.

It was not until the middle of the nineteenth century that cannabis-based medicines were introduced into the West. The tinctures were used orally for the treatment of seizures, neuralgia, insomnia, and dysmenorrhea, among other illnesses. The cannabis-based medications were administered through an alcohol-based extract of hemp plants that were lacking in the most pharmacologically active ingredients, especially tetrahydrocannabinol (THC).

During most of the twentieth century there has been little interest in or advance of the medical use of cannabis. It has been legally prohibited in the United States since 1937. Occasionally small amounts of oil extract have been made available to some licensed university researchers for animal studies. One of the prior authors (Stephen Rosenblatt, M.D., Ph.D.) did animal research from 1969 through 1971 on learning and memory in rats, using injectable THC oil. Little to no human research on the medical uses of cannabis has been done in recent years. It is believed that, to the extent not already legalized, full state and federal legalization of cannabis related products is imminent.

In preparation for the continued growth of the cannabis market, scientists and producers have begun experimenting with many different cannabis infused products. Oils and tinctures are amongst those products being sought after, but the variety of these products has been limited thus far. In light of the foregoing, it would be desirable to devise an improved process for producing a cannabis infused olive oil that may be useful for home administration and/or treatment of discomfort.

### BRIEF DESCRIPTION OF THE DRAWINGS

FIG. 1 is a flow diagram illustrating process for making cannabis infused olive oil, according to an embodiment of the present disclosure.

FIG. 2 is a flow diagram illustrating a process for making cannabis infused olive oil, according to an embodiment of the present disclosure.

FIG. 3 is a flow diagram illustrating a process for making an infused olive oil, according to an embodiment of the present disclosure.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

Generally speaking, this application relates to a specified model and prototype for a heat induction process of cannabis infused olive oil. In this process, the olive oil of choice includes cold-pressed Kalamata olive oil. The cannabis may be introduced to the oil medium in the form of flower trim and micro-buds for slow infusion. This process is believed to be superior as it incorporates organic materials and is simple to perform, easy to repeat, and the oil used may not overheat to counteract and/or destroy the THC in the cannabis. Additionally, this process does not require any solvents or other harmful chemicals.

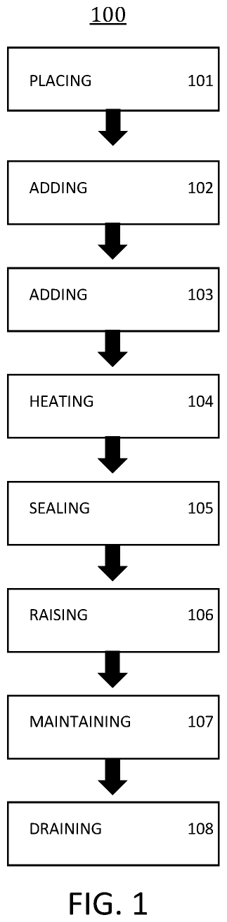

Referring to FIG. 1, a process 100 for making cannabis infused olive oil is disclosed. The process 100 may include the steps of placing 101 an empty drum on a heating plate. The heating plate used may be an induction heater. The drum may include a lid with a press plate. From there, olive oil may be added 102 to the drum. Additionally, a biological mass may then be added 103 to the drum. The drum is then heated 104 to 25 degrees Celsius. Next, the drum is then sealed 105 with the lid.

After the drum is sealed 105, a user may then raise 106 the temperature in the drum by 5 degrees Celsius every two days until the temperature of 40 degrees Celsius has been reached. The temperature of the drum is then maintained 107 at a continuous level of 40 degrees Celsius for a period of one week. The final step is then to drain 108 the oil and filter the results into a receiving container.

In the process described above, the biological mass may include cannabis. The olive oil used may be cold-pressed extra virgin Kalamata oil. In a preferred embodiment, additional steps may include a process of testing the contents of the drum for quality after the contents have reached their target temperature of 40 degrees Celsius. Although other tests may be called for in addition, the process of testing the contents may include at least some form of verifying the smell and taste of the resulting product.

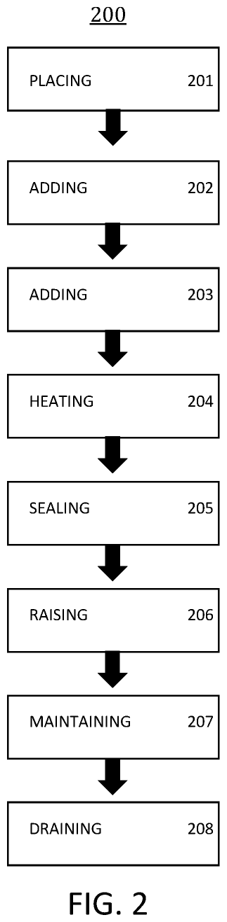

Referring now to FIG. 2, a process 200 for making cannabis infused olive oil is disclosed. The process 200 may include the steps of placing 201 an empty drum on a heating plate. The heating plate used may be an induction heater. The drum may include a lid with a press plate. From there, cold-pressed extra virgin olive oil may be added 202 to the drum. Additionally, a cannabis ingredient may then be added 203 to the drum. The drum is then heated 204 to 25 degrees Celsius. Next, the drum is then sealed 205 with the lid.

After the drum is sealed 205, a user may then raise 206 the temperature in the drum by 5 degrees Celsius every two days until the temperature of 40 degrees Celsius has been reached. The temperature of the drum is then maintained 207 at a continuous level of 40 degrees Celsius for a period of one week. The final step is then to drain 108 the oil and filter the results into a receiving container.

In a preferred embodiment, additional steps performed may include a process of testing the contents of the drum for quality after the contents have reached their target temperature of 40 degrees Celsius. Although other tests may be called for in addition, the process of testing the contents may include at least some form of verifying the smell and taste of the resulting product.

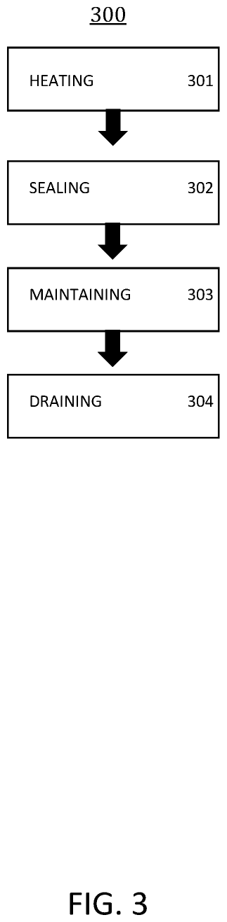

Referring to FIG. 3, a process 300 for making an infused olive oil is disclosed. The process 300 may include the steps of heating 301 a drum on a heating plate to approximately 25 degrees Celsius. The heating plate used may be an induction heater. The drum may include a lid with a press plate and may contain cold-pressed extra virgin olive oil and a biomass substance. Next, the drum is sealed 302 and the temperature is raised 5 degrees Celsius every two days.

Once the drum reaches 40 degrees Celsius, the temperature of the drum is then maintained 303 at a continuous level of 40 degrees Celsius for a period of one week. The final step is then to drain 304 the oil into a receiving container. In this process, the olive oil used may be cold-pressed extra virgin Kalamata oil and the biomass substance may contain cannabis. Additional steps may include a process of testing the contents of the drum for quality after the contents have reached their target temperature of 40 degrees Celsius. Although other tests may be called for in addition, the process of testing the contents may include at least some form of verifying the smell and taste of the resulting product.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

It should be noted that the consumption of Cannabis related products is still illegal in some states and countries. In some states and countries, Cannabis products may only be used for medical purposes. In other states and countries, Cannabis and Cannabis products may be used both for health purposes and for recreational purposes. The present invention, and this patent application in particular, relates to the legal use of Cannabis products. No illegal use of such products is encouraged or suggested.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

I claim:

1. A process for making cannabis infused olive oil comprising:
placing an empty drum on a heating plate, said drum having a lid with a press plate;
adding olive oil to the drum;
adding a biological mass to the drum;
heating the drum to 25 degrees C., then sealing the drum with the lid;
raising temperature in the drum by 5 degrees C. every two days until reaching 40 degrees C.
maintaining heat continuously at 40 degrees C. for one week;
draining oil and filter into a receiving container.

2. The process of claim 1 wherein the biological mass includes cannabis.

3. The process of claim 1 wherein the olive oil is cold-pressed extra virgin Kalamata oil.

4. The process of claim 1 wherein the heating plate is an induction heater.

5. The process of claim 1 further comprising testing contents of the drum for quality when said contents first reach 40 degrees C.

6. The process of claim 5 wherein said testing contents for quality includes at least testing for smell and taste.

7. A process for making cannabis infused olive oil comprising:
placing an empty drum on a heating plate, said drum having a lid with a press plate;
adding cold-pressed extra virgin olive oil to the drum;
adding a cannabis to the drum;
heating the drum to 25 degrees C., then sealing the drum with the lid;
raising temperature in the drum by 5 degrees C. every two days until reaching 40 degrees C.
maintaining heat continuously at 40 degrees C. for one week;
draining oil and filter into a receiving container.

8. The process of claim 7 wherein the cold-pressed extra virgin olive oil is Kalamata oil.

9. The process of claim 7 wherein the heating plate is an induction heater.

10. The process of claim 7 further comprising testing contents of the drum for quality when said contents first reach 40 degrees C.

11. The process of claim 10 wherein said testing for quality includes testing for smell and taste.

12. A process for making an infused olive oil comprising the steps of:
heating a drum on a heating plate to approximately 25 degrees Celsius said drum containing cold-pressed extra virgin olive oil and a biomass substance;
sealing the drum and continuing to heat the drum raising temperature 5 degrees Celsius every two days;
maintaining said temperature at 40 degrees Celsius for at least one week;
draining the oil from the drum into a receiving container.

13. The process of claim 12 wherein the cold-pressed extra virgin olive oil is Kalamata oil.

14. The process of claim 12 wherein the biomass substance contains cannabis.

15. The process of claim 12 wherein the heating plate is an induction heater.

16. The process of claim 12 further comprising testing contents of the drum for quality when said contents first reach 40 degrees C.

17. The process of claim 15 wherein said testing contents for quality includes at least testing for smell and taste.
